(19) United States
(12) Patent Application Publication
(10) Pub. No.: US 2014/0274241 A1
(43) Pub. Date: Sep. 18, 2014

(54) SCHEME FOR REQUIRING ADDITIONAL USER INPUT WHEN CATCHING AN OBJECT IN A COMPUTER SIMULATION

(71) Applicant: Sony Computer Entertainment America LLC, San Mateo, CA (US)

(72) Inventor: Edward R. CRAMM, Austin, TX (US)

(21) Appl. No.: 13/830,673

(22) Filed: Mar. 14, 2013

(51) Int. Cl. A63F 13/00

(52) U.S. Cl. CPC A63F 13/005
USPC 463/4

(57) ABSTRACT

A method includes displaying a character on a display, wherein movements of the character are controllable by a user, displaying an object on the display and causing the object to appear to be moving, causing the character to appear to be attempting to catch the object in response to control input received from the user, receiving a catch command input from the user, and causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object. A storage medium and system are included.

### BACKGROUND OF THE INVENTION

1. Field of the Invention

The present invention relates generally to computer software applications, and more specifically to computer simulations, computer games, and video games.

2. Discussion of the Related Art

Computer games, such as video games, have become a popular source of entertainment. Computer games are typically implemented in computer game software applications and are often run on game consoles, entertainment systems, desktop, laptop, and notebook computers, portable devices, pad-like devices, etc.

Computer games are one type of computer simulation. The user of a computer game is typically able to view the game play on a display and control various aspects of the game with a game controller, game pad, joystick, mouse, or other input devices and/or input techniques.

### SUMMARY OF THE INVENTION

One embodiment provides a non-transitory computer readable storage medium storing one or more computer programs adapted to cause a processor based system to execute steps comprising: displaying a character on a display, wherein movements of the character are controllable by a user; displaying an object on the display and causing the object to appear to be moving; causing the character to appear to be attempting to catch the object in response to control input received from the user; receiving a catch command input from the user; and causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

Another embodiment provides a method, comprising: displaying, by a processor based apparatus, a character on a display, wherein movements of the character are controllable by a user; displaying an object on the display and causing the object to appear to be moving; causing the character to appear to be attempting to catch the object in response to control input received from the user; receiving a catch command input from the user; and causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

Another embodiment provides a system, comprising: a display; and a processor based apparatus that is configured to display a character on a display, wherein movements of the character are controllable by a user, display an object on the display and causing the object to appear to be moving, cause the character to appear to be attempting to catch the object in response to control input received from the user, receive a catch command input from the user, and cause the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIGS. 1, 2, and 3 are screen shots illustrating a method in accordance with an embodiment of the present invention;

FIG. 4 is a diagram illustrating a method in accordance with an embodiment of the present invention;

FIG. 5 is a perspective view illustrating an input device that may be used with embodiments of the present invention;

FIG. 6 is a screen shot illustrating a method in accordance with an embodiment of the present invention;

FIG. 7 is a flow diagram illustrating a method in accordance with an embodiment of the present invention; and

FIG. 8 is a block diagram illustrating a computer or other processor based apparatus/system that may be used to run, implement and/or execute any of the methods and techniques shown and described herein in accordance with the embodiments of the present invention.

### DETAILED DESCRIPTION

Sports video games are a popular type of computer game. Sports video games simulate the practice of traditional sports, such as for example, baseball, football, basketball, soccer, hockey, etc. The players in a sports video game may be represented by animated characters and/or avatars on the display screen. The user of such a game is typically able to control various aspects of the game play, such as an individual player or an entire team.

By way of example, the user of a sports video game is often able to control a player avatar in the game so as to catch a ball or other object. For example, in a baseball video game the user is often able to control a player avatar to catch a baseball, such as a fly ball. In a football video game the user is often able to control a player avatar to catch a football, such as a pass from the quarterback or a kick off. Such games are similar to first-person games, except that in some cases the user is able to see and/or view more of the player avatar than is typically seen in many first-person games.

Sometimes the user of a computer game, such as a sports video game, wants to experience a greater challenge in performing certain actions of the game. Some of the embodiments of the present invention provide a feature that can give the user a greater challenge when controlling his or her character, such as a player in a sports video game, so as to catch an object, such as a ball. By way of example, some embodiments of the present invention may be used to provide a user catch option (also called a manual catch option) in a baseball video game that can help the user experience a greater challenge and/or a more realistic feel when controlling and causing his or her on-screen player to catch the baseball. The use of embodiments of the present invention in baseball video games is just one example and it should be understood that embodiments of the present invention may be used in many other types of sports video games as well as many other types of computer games.

The following discussion will focus on an example embodiment of the present invention that is used to provide a user catch option (or a manual catch option) in a baseball video game. Specifically, in some embodiments the user controls a player avatar that is playing one of the fielding positions. In some embodiments the user control may comprise first-person control or be similar to first-person control. In some embodiments the user catch option may comprise a first-person user catch mode mechanic. But use of the first-person mode is not required.

When the batter avatar hits the ball, the user controls his or her player in an attempt to make the player catch the ball. In some embodiments, the user must cause the player to move to a catch region, which is a region or location on the field where the player will be able to catch the ball. Namely, the catch region is a region located at or near where the ball will first hit the ground after flying. As such, the player will be able to catch the ball at or near the catch region. In some embodiments, the catch region is determined by factors that include the speed, height, and trajectory of the ball. In some embodiments, a catch region visual indicator is displayed to identify the location of the catch region for the user. The catch region visual indicator identifying the location of the catch region is an optional feature and even if it is displayed it may not always be visible to the user depending on the location of the player and the camera orientations. Furthermore, use of the catch region in general is an optional feature. In some embodiments, a catch region is not used and there is no defined catch region.

In some embodiments, the user catch option provides that the user is required to press a button on the game controller, game pad, or other input device in order to make his or her on-screen player catch the ball. In general, the user is required to press the button as the ball gets closer to the on-screen player's baseball glove. The particular button on the game controller or game pad may comprise any button. In some embodiments, the particular button on the game controller or game pad may comprise the L2 button, but use of the L2 button is not required.

Referring to FIG. 1, there is illustrated a screen shot illustrating the operation of a user catch option (or a manual catch option) in accordance with an embodiment of the present invention. A display 100 displays a scene in a baseball video game that is viewed by a user (not shown). A baseball player 102 is shown in the infield 104. The user's view is from just behind the player 102 looking towards first base 106, the pitcher's mound 108, and the audience stands 110. The movements of the player 102 are controllable by the user via any type of control means, such as for example a game controller, game pad, etc.

As shown, a baseball 112 has just been hit by a batter and the baseball 112 is moving. By way of example, the baseball 112 may be moving as a ground ball where it may be moving close to the ground and bouncing off the ground as it travels. Or the baseball 112 may be moving as a fly ball wherein it is flying through the air. In some embodiments, an optional halo 114 may be displayed around the baseball 112 as it moves. The optional halo 114 may be displayed in various different colors and helps the user to locate and see the baseball 112.

The user will attempt to control the player 102 in such a way as to make the player 102 catch the baseball 112. The player 102 will catch the baseball 112 by using a catching element, which in the illustrated embodiment comprises a baseball glove 116. In some embodiments, the catching element may comprise the player 102's bare hand or any other member or means for catching.

Referring to FIG. 2, the baseball 112 has moved/traveled farther, and the user moves the player 102 towards the baseball 112 in order to attempt to catch the baseball 112. The user controls and moves the player 102 using any type of control means, such as for example a game controller, game pad, etc. In response to the control input received from the user, the video game or other computer simulation causes the player 102 to appear to be attempting to catch the baseball 112. For example, as illustrated, the player 102 is bending over and begins to reach out his baseball glove 116 in an attempt to catch the baseball 112.

Referring to FIG. 3, the baseball 112 has moved/traveled even farther, and the user has moved the player 102 so as to intersect with the path of the baseball 112. The baseball 112 is very close to the player 102, and the player 102 is reaching down his baseball glove 116 in an attempt to align the glove with the path of the baseball 112. The user has been controlling the actions of the player 102, and in response to the control input received from the user, the video game or other computer simulation continues to cause the player 102 to appear to be attempting to catch the baseball 112.

Referring to FIG. 4, there is illustrated a close up view of the baseball 112 as it closes in on the baseball glove 116 of the player 102. Also shown is the optional ball halo 114 which may be displayed around the baseball 112 as it moves, which may be displayed in various different colors and helps the user to locate and see the baseball 112.

In some embodiments, in order for the player 102 to successfully catch the baseball 112 a set of conditions must be met. In some embodiments, the set of conditions may include only one condition. In some embodiments, the set of conditions may include two, three, four, or more conditions.

In some embodiments, one condition that must be met in order for the player 102 to successfully catch the baseball 112 is that the baseball 112 must be substantially aligned with the catching element of the player 102, which in this embodiment is the baseball glove 116. An example of such alignment is illustrated by the axis 120 which passes through the center of the baseball 112 and the pocket of the baseball glove 116. In order to achieve such alignment, the user must manipulate the game controller, control pad, or other input device so as to put the player 102 and the baseball glove 116 in a position and location so that the baseball 112 is substantially aligned with the baseball glove 116. Such position and location may also be referred to as a “zone” that the player 102 needs to be in to catch the ball. This is often quite challenging for the user given that the baseball 112 is typically moving (e.g. flying or bouncing off the ground), often at a very high rate of speed.

In some embodiments, another condition that must be met in order for the player 102 to successfully catch the baseball 112 is that the player 102 must be oriented in a manner suitable for catching the baseball 112. Many different player orientations are possible for catching the ball. For example, in some embodiments the player 102 should generally be facing the baseball 112, but this is not always required. In some embodiments, the player 102 should be oriented in a manner such that it is possible for the player 102 to catch the baseball 112. For example, in some embodiments it would normally not be possible for the player 102 to catch the baseball 112 if the player 102 is not facing the baseball 112 or he has his baseball glove 116 oriented such that the baseball 112 will hit the back of the glove 116.

As mentioned above, in some embodiments the user catch option (or a manual catch option) provides that the user is required to press a button on the game controller, game pad, or other input device in order to make his or her on-screen player catch the ball. Thus, in some embodiments that is one condition that must be met in order for the player 102 to successfully catch the baseball 112. For example, in some embodiments, one condition that must be met in order for the player 102 to successfully catch the baseball 112 is that the baseball 112 must be within a predetermined distance from the baseball glove 116 at a time of receipt of a catch command input from the user. In some embodiments, one condition that must be met in order for the player 102 to successfully catch the baseball 112 is that the baseball 112 must be within a predetermined distance from the baseball glove 116 at a time of receipt of a catch command input from the user and the player 102 is also oriented in a manner suitable for catching the baseball 112.

For example, in some embodiments, in order to successfully catch the baseball 112, the baseball 112 must be within a predetermined distance D₁ from the baseball glove 116 at a time of receipt of a catch command input from the user. That is, in such an embodiment, the video game will cause the player 102 to appear to successfully catch the baseball 112 if the baseball 112 is within the predetermined distance D₁ from the baseball glove 116 of the player 102 at the time of receipt of the catch command input from the user. As such, the user's timing must be such that the user triggers the catch command input when the baseball 112 is a distance of D₁ or less from the baseball glove 116. This requirement (of some embodiments) that the user trigger the catch command input at just the right time in order to catch the baseball 112 can provide the user with a challenging and realistic baseball experience.

In general, the longer the predetermined distance between the baseball 112 and the glove 116, the easier the timing will be for the user to trigger the catch command input. In order to provide the user with an even greater challenge, the predetermined distance may be decreased. For example, in some embodiments, in order to successfully catch the baseball 112, the baseball 112 must be within a predetermined distance D₂ from the baseball glove 116 at a time of receipt of a catch command input from the user. This shorter predetermined distance means that the user's timing must be more precise. In some embodiments, for a still greater challenge for the user, the predetermined distance D₃ may be used. That is, in such an embodiment, the video game will cause the player 102 to appear to successfully catch the baseball 112 if the baseball 112 is within the predetermined distance D₃ from the baseball glove 116 of the player 102 at the time of receipt of the catch command input from the user.

Thus, in some embodiments, when catching a ball the user will be required to provide a catch command input to the game console, entertainment system, or other device, with the correct timing as described above. In some embodiments, the receiving a catch command input from the user comprises receiving a signal from an input device that is manipulated by the user. In some embodiments, the signal from the input device is generated in response to a button on the input device being pressed by the user. The particular button on the input device may comprise any button. In some embodiments, the catch command input from the user is generated by the user manipulating the input device in some other way, such as by pressing a combination of buttons, or manipulating a joystick, or moving or gesturing the controller in some manner, etc.

The input device may comprise any type of input device or input technique or method. For example, the input device may comprise a game controller, game pad, joystick, mouse, wand, or other input devices and/or input techniques. The input device may be wireless or wired. FIG. 5 illustrates an example of an input device 130 that may be used in some embodiments. The input device 130 comprises an example of a game controller or game pad. In some embodiments, the particular button on the input device 130 that may be used to trigger the catch command input may comprise the L2 button, but use of the L2 button is not required. Any button or control on the input device 130 may be used to trigger the catch command input.

In some embodiments, the user catch option (also called manual catch option) may be implemented as an optional feature that can be turned on by the user in a menu for the video game or other computer simulation. FIG. 6 illustrates an example of such a menu in accordance with some embodiments. The “Game Play Menu” may be displayed on the display 100. As illustrated the “Manual Catch Option” is currently turned “on” but can easily be turned “off” by the user. In some embodiments, the “Manual Catch Option” may be defaulted “off” but can be turned “on” in the menu by the user for a greater challenge. Thus, in some embodiments, when the “Manual Catch Option” is turned “on” the user is required to press a button with the correct timing to catch a ball, and when the “Manual Catch Option” is turned “off” the user is not required to press a button with the correct timing to catch a ball. Therefore, in some embodiments the video game, computer game, computer simulation, or other software application, can display a menu that gives the user an option to turn off use of the catch command input so that receipt of the catch command input will not be a condition that needs to be met for causing the on-screen player to appear to successfully catch the ball.

Referring to FIG. 7, there is illustrated an example of a method 700 that operates in accordance with an embodiment of the present invention. In some embodiments, the method 700 may be used for providing a user catch option (also called manual catch option) as described above. The method 700 may be used in any type of computer game, video game, sports video game, etc. Furthermore, the method 700 may be used in any mode of such games. For example, the method 700 may be used in a single player mode, a career mode, team mode, franchise mode, etc. Furthermore, in some embodiments the feature provided by the method 700 may include means for allowing the feature to be enabled or disabled by the user. This means the user can decide if he or she wants to use the feature.

The method 700 begins in step 702 in which a character is displayed on a display. The movements of the character are controllable by a user. In some embodiments the character comprises a player, such as a player in a sports video game.

In step 704 an object is displayed on the display. The object is made to move so as to cause it to appear to be moving. The object may be made to move in any manner, such as close to the ground, bouncing along the ground, rolling on the ground, flying high in the air, or in any other manner. In some embodiments, the object may be moving like a ground ball where it may be moving close to the ground and bouncing off the ground as it travels. Or the object may be moving as a fly ball wherein it is flying through the air. In some embodiments the object comprises a ball. For example, in some embodiments the object may appear to be a baseball that has been batted by a baseball player.

In step 706 the character is made to appear to be attempting to catch the object in response to control input received from the user. For example, the user controls the movements of the displayed character with an input device and attempts to make the character catch the object.

In step 708, a catch command input is received from the user. In some embodiments, the user must provide the catch command input within the correct timing in order for the displayed character to successfully catch the object.

In step 710, the character is made to appear to successfully catch the object if a set of at least one condition(s) are all met. In some embodiments, the set of at least one condition(s) may include only one condition. In some embodiments, the set of at least one condition(s) may include two or more conditions. In some embodiments, the set of at least one condition(s) comprises that the object is within a predetermined distance from a catching element of the character at a time of receipt of the catch command input. Again, in some embodiments, this may be the only condition that needs to be met in order to catch the object since as stated above the set of at least one condition(s) may include only one condition. In some embodiments, the set of at least one condition(s) comprises that the object is within a predetermined distance from a catching element of the character at a time of receipt of the catch command input and the character is oriented in a manner suitable for catching the object at the time of receipt of the catch command input.

As mentioned above, many different character orientations are possible for catching the ball. For example, in some embodiments the character should generally be facing the object, but this is not always required. In some embodiments, the character should be oriented in a manner such that it is possible for the character to catch the object. For example, in some embodiments it would normally not be possible for the character to catch the object if the character is not facing the object or the catching element of the character is oriented with its non-catching back portion towards the object.

In embodiments where the set of at least one condition(s) includes two or more conditions, the set of at least one condition(s) may further comprise that the object is substantially aligned with the catching element of the character at a time of receipt of the catch command input.

Thus, in some embodiments, in order to catch the object, the character must be oriented in a manner suitable for catching the object, the catching element of the character must be substantially aligned with the object, and the object must be within a predetermined distance from the catching element of the character at a time of receipt of the catch command input.

In some embodiments, the catching element of the character comprises a glove worn by the character, such as a baseball glove. In some embodiments, the catching element of the character comprises a hand of the character. In some embodiments, the catching element may comprise any other member or means for catching.

In step 712, which is optional, a menu is displayed that gives the user an option to turn off use of the catch command input so that receipt of the catch command input will not be a condition that needs to be met for causing the character to appear to successfully catch the object. In some embodiments, this step allows the user turn off the manual catch option to make catching the object easier, or turn on the manual catch option to make catching more difficult for a greater challenge.

In some embodiments, the user catch option (also called manual catch option) described above can give the user more control in catching an object and gives the user more to do when catching an object. In some embodiments, the user catch option may be turned “off” as a default in the software application in which it is implemented. The user can easily turn “on” the user catch option in a menu to provide the user with a greater challenge. When turned “on” the user is required to provide a catch command input with the correct timing in order for his or her on screen character to catch the object. In some embodiments, the catch command input can be provided by the user pressing a button on an input device. So for example, the user may be required to press L2 on a game pad to catch the ball when the ball gets within a certain distance of the user's fielder's glove. When the user catch option is turned “off”, the user is not required to provide a catch command input with the correct timing in order for his or her on screen character to catch the object. The user catch option (also called manual catch option) is believed to be a fun feature that should provide the user with a challenging and realistic feel. In some embodiments, it may be used in a first-person game or mode, or be used in a game or mode that is similar to first-person control.

The methods and techniques described herein may be utilized, implemented and/or run on many different types of processor based apparatuses or systems. For example, the methods and techniques described herein may be utilized, implemented and/or run on computers, servers, game consoles, entertainment systems, portable devices, pad-like devices, etc. Furthermore, the methods and techniques described herein may be utilized, implemented and/or run in online scenarios or networked scenarios, such as for example, in online games, online communities, over the Internet, etc.

Referring to FIG. 8, there is illustrated an example of a processor based apparatus or system 800 that may be used for any such implementations. One or more components of the processor based apparatus or system 800 may be used for implementing any method, system, or device mentioned above, such as for example any of the above-mentioned computers, servers, game consoles, entertainment systems, portable devices, pad-like devices, etc. However, the use of the processor based apparatus or system 800 or any portion thereof is certainly not required.

By way of example, the system 800 may include, but is not required to include, a central processing unit (CPU) 802, a graphics processing unit (GPU) 804, a random access memory (RAM) 808, and a mass storage unit 810, such as a disk drive. The system 800 may be coupled to, or integrated with, any of the other components described herein, such as a display 812 and/or an input device 816. In some embodiments, the system 800 comprises an example of a processor based apparatus or system. In some embodiments, such a processor based apparatus or system may also be considered to include the display 812 and/or the input device 816. The CPU 802 and/or GPU 804 may be used to execute or assist in executing the steps of the methods and techniques described herein, and various program content, images, avatars, characters, players, menu screens, video games, virtual worlds, graphical user interface (GUI), etc., may be rendered on the display 812.

The input device 816 may comprise any type of input device or input technique or method. For example, the input device 816 may comprise a game controller, game pad, joystick, mouse, wand, or other input devices and/or input techniques. The input device 816 may be wireless or wired, e.g. it may be wirelessly coupled to the system 800 or comprise a wired connection. In some embodiments, the input device 816 may comprise means or sensors for sensing and/or tracking the movements and/or motions of a user and/or an object controlled by a user. The display 812 may comprise any type of display or display device or apparatus.

The mass storage unit 810 may include or comprise any type of computer readable storage or recording medium or media. The computer readable storage or recording medium or media may be fixed in the mass storage unit 810, or the mass storage unit 810 may optionally include removable storage media 814, such as a digital video disk (DVD), Blu-ray disc, compact disk (CD), USB storage device, floppy disk, or other media. By way of example, the mass storage unit 810 may comprise a disk drive, a hard disk drive, flash memory device, USB storage device, Blu-ray disc drive, DVD drive, CD drive, floppy disk drive, etc. The mass storage unit 810 or removable storage media 814 may be used for storing code or macros that implement the methods and techniques described herein.

Thus, removable storage media 814 may optionally be used with the mass storage unit 810, which may be used for storing program or computer code that implements the methods and techniques described herein, such as program code for running the above-described methods and techniques. However, any of the storage devices, such as the RAM 808 or mass storage unit 810, may be used for storing such code. For example, any of such storage devices may serve as a tangible non-transitory computer readable storage medium for storing or embodying a computer program or software application for causing a console, system, computer, client, server, or other processor based apparatus or system to execute or perform the steps of any of the methods, code, and/or techniques described herein. Furthermore, any of the storage devices, such as the RAM 808 or mass storage unit 810, may be used for storing any needed database(s).

In some embodiments, one or more of the embodiments, methods, approaches, and/or techniques described above may be implemented in one or more computer programs or software applications executable by a processor based apparatus or system. By way of example, such processor based system may comprise the processor based apparatus or system 800, or a computer, entertainment system, game console, graphics workstation, server, client, portable device, pad-like device, etc. Such computer program(s) may be used for executing various steps and/or features of the above-described methods and/or techniques. That is, the computer program(s) may be adapted to cause or configure a processor based apparatus or system to execute and achieve the functions described above. For example, such computer program(s) may be used for implementing any embodiment of the above-described methods, steps, techniques, or features. As another example, such computer program(s) may be used for implementing any type of tool or similar utility that uses any one or more of the above described embodiments, methods, approaches, and/or techniques. In some embodiments, one or more such computer programs may comprise a computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods and/or techniques. In some embodiments, the computer program(s) may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides one or more non-transitory computer readable storage mediums storing one or more computer programs adapted to cause a processor based apparatus or system to execute steps comprising: displaying a character on a display, wherein movements of the character are controllable by a user; displaying an object on the display and causing the object to appear to be moving; causing the character to appear to be attempting to catch the object in response to control input received from the user; receiving a catch command input from the user; and causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

While the invention herein disclosed has been described by means of specific embodiments and applications thereof, numerous modifications and variations could be made thereto by those skilled in the art without departing from the scope of the invention set forth in the claims.

What is claimed is:

1. A non-transitory computer readable storage medium storing one or more computer programs adapted to cause a processor based system to execute steps comprising:
displaying a character on a display, wherein movements of the character are controllable by a user;
displaying an object on the display and causing the object to appear to be moving;
causing the character to appear to be attempting to catch the object in response to control input received from the user;
receiving a catch command input from the user; and
causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

2. The non-transitory computer readable storage medium of claim 1, wherein the set of at least one condition(s) further comprises that the object is substantially aligned with the catching element of the character at a time of receipt of the catch command input.

3. The non-transitory computer readable storage medium of claim 1, wherein the one or more computer programs are further adapted to cause the processor based system to execute steps comprising:
displaying a menu that gives the user an option to turn off use of the catch command input so that receipt of the catch command input will not be a condition that needs to be met for causing the character to appear to successfully catch the object.

4. The non-transitory computer readable storage medium of claim 1, wherein the one or more computer programs are further adapted to cause the processor based system to execute steps comprising:
displaying a halo around the object as the object moves.

5. The non-transitory computer readable storage medium of claim 1, wherein the receiving a catch command input from the user comprises receiving a signal from an input device.

6. The non-transitory computer readable storage medium of claim 5, wherein the signal from the input device is generated in response to a button on the input device being pressed.

7. The non-transitory computer readable storage medium of claim 1, wherein the catch command input from the user is generated by the user manipulating an input device.

8. The non-transitory computer readable storage medium of claim 1, wherein the catching element of the character comprises a glove worn by the character.

9. The non-transitory computer readable storage medium of claim 1, wherein the catching element of the character comprises a hand of the character.

10. The non-transitory computer readable storage medium of claim 1, wherein the character comprises a player in a sports video game.

11. The non-transitory computer readable storage medium of claim 1, wherein the object comprises a ball.

12. The non-transitory computer readable storage medium of claim 1, wherein the character comprises a baseball player in a baseball video game, the catching element of the character comprises a baseball glove worn by the character, and the object comprises a baseball.

13. A method, comprising:
displaying, by a processor based apparatus, a character on a display, wherein movements of the character are controllable by a user;
displaying an object on the display and causing the object to appear to be moving;
causing the character to appear to be attempting to catch the object in response to control input received from the user;
receiving a catch command input from the user; and
causing the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.

14. A system, comprising:
a display; and
a processor based apparatus that is configured to display a character on a display, wherein movements of the character are controllable by a user, display an object on the display and causing the object to appear to be moving, cause the character to appear to be attempting to catch the object in response to control input received from the user, receive a catch command input from the user, and cause the character to appear to successfully catch the object if a set of at least one condition(s) are all met, wherein the set of at least one condition(s) comprises that the object is within a predetermined distance from a catching element of the character at a time of receipt of the catch command input and wherein the character is oriented in a manner suitable for catching the object.
